(19) United States
(12) Patent Application Publication
(10) Pub. No.: US 2004/0210669 A1
(43) Pub. Date: Oct. 21, 2004

(54) Apparatus and method for distributing packet without IP reassembly

(75) Inventor: Jun-seo Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/786,326

(22) Filed: Feb. 26, 2004

(30) Foreign Application Priority Data
Mar. 12, 2003 (KR) 10-2003-0015539

(51) Int. Cl. G06F 15/16

(52) U.S. Cl. 709/236

(57) ABSTRACT

A method for receiving packets from a network and distributing the packets to corresponding protocol processors, includes determining whether a received fragmented packet is a first fragment; if the received packet is the first fragment, looking-up its tunnel ID and its fragment ID, and comparing the result of the looked-up fragment ID with each list of a fragment look-up table, into which the results of fragment look-ups on received packets are entered, to determine if there is a corresponding list; searching an index corresponding to the tunnel ID of the received packet from a tunnel ID look-up table, and if the list conforming to the result of the looked-up fragment ID exists in the fragment look-up table, entering the index into the corresponding list of the fragment look-up table; and attaching the index as a tag to the received packet and transmitting the received packet to the corresponding protocol processor.

### CROSS-REFERENCE TO RELATED APPLICATIONS

This application claims the benefit of Korean Patent Application No. 10-2003-0015539 filed Mar. 12, 2003, in the Korean Intellectual Property Office, the disclosure of which is incorporated herein by reference.

### BACKGROUND OF THE INVENTION

1. Field of the Invention

The present invention generally relates to a packet distribution apparatus and a packet distribution method, and more particularly to a packet distribution apparatus having a forwarding engine and a packet distribution method capable of distributing packets to a plurality of protocol processors without reassembling the packets, if the packets being received are packets that are fragmented.

2. Description of the Related Art

GTP (GPRS Tunneling Protocol), L2TP (Layer 2 Tunneling Protocol), and Mobile IP are IP-based tunneling protocols, and IP-based tunneling is referred to as the technology for encapsulating packets and enhancing the security of the packets according to each network's protocol when data is subjected to IP packet processing in a communications network. By this tunneling, each of the packets is encapsulated and transmitted via a path (to be referred to as a “tunnel”) formed on the Internet and undetectable to the human eye. Each tunnel has a unique ID for discriminating its own tunnel from others, with the ID being referred to as a tunnel ID.

The terminal of such a tunnel simultaneously processes a large number of packets that are transmitted in the manner described above using a forwarding engine. Typically, in order to process a large number of packets, a method employing a plurality of protocol processors for processing the packets is applied.

In the case of employing the plurality of protocol processors, the forwarding engine is required to classify a number of packets received based on the tunnel ID, and distribute them to each protocol processor.

Generally, in data communications on a network, data is packetized and transmitted in a packet unit. The packet size is normalized for each network. In the case of an IP datagram having a greater size than the normalized packet size, the datagram is fragmented into a plurality of packets (hereinafter, each being referred to as a “fragment”) before being transmitted. All of the packets that are fragmented from one IP datagram include an IP header, respectively. However, a GTP header, L2TP header, or intra IP header (in case of mobile IP), which includes the tunnel ID, is included in only a first fragment. Accordingly, it is impossible to look-up the tunnel ID in subsequent fragments, following the first fragment, resulting in an inability to distribute the IP datagram without a special process.

Therefore, in accordance with the prior art, the fragments are reassembled and the tunnel ID of the reassembled packet is looked-up, thereby distributing the packets.

FIG. 1 is a block diagram showing a prior art packet distribution apparatus having the forwarding engine. With reference to FIG. 1, the packet distribution apparatus having the forwarding engine 100 comprises a tunnel ID look-up device 101, a tunnel ID look-up table storage unit 103, a receiving unit 105, a transmitting unit 107, and a dependant interface 109. The tunnel ID look-up device 101 looks-up the tunnel ID of the reassembled packet, searches an index, which indicates one of a plurality of protocol processors 1 corresponding to the looked-up tunnel ID from the tunnel ID look-up table stored in the tunnel ID look-up table storage unit 103, attaches the index to the reassembled packet as a tag, and distributes the reassembled packet to the corresponding one of the plurality of protocol processors 1. Since this prior art packet distribution apparatus having the forwarding engine 100 does not include hardware for reassembling the packets, the apparatus 100 has applied a method in which the packets are reassembled in a call establishing processor (not shown) in the upper layer, the tunnel ID of the reassembled packet is looked-up, and the reassembled packet is distributed to the corresponding protocol processor.

However, on the system architecture, the primary function of the call establishing processor (not shown) is to establish and manage the call. Consequently, if the call establishing processor (not shown) performs the packet reassembly, the call management performance of the call establishing processor (not shown) may be degraded, and therefore, there exists a problem that the general operations of the system become inefficient.

FIG. 2 is a block diagram showing another prior art packet distribution apparatus having the forwarding engine. With reference to FIG. 2, the packet distribution apparatus with the forwarding engine 200 comprises all the constituents of the packet distribution apparatus 100 shown in FIG. 1, and further comprises IP reassembly device 211, a fragment look-up table storage unit 213, and a fragment buffer 215.

If the IP reassembly device 211 receives the fragments, the device 211 reassembles each fragment into one IP packet using the fragment look-up table held in the fragment look-up table storage unit 213 and the fragment buffer 215. Accordingly, the tunnel ID look-up device 201 looks-up the tunnel ID of the reassembled IP packet, and hence distributes the reassembled packet to one of the protocol processors 2.

As such, reassembling IP packets in hardware is difficult in the hardware implementation. Additionally, a problem occurs in terms of the resource and cost of the processor, considering that typically IP reassembling is implemented in software.

### SUMMARY OF THE INVENTION

The present invention is made in order to overcome the problems described above. Therefore, in an effort to solve the problems as described above, it is an exemplary aspect of the present invention to provide a packet distribution apparatus and a packet distribution method in which in a case that the packets received are fragmented packets (i.e., fragments), the packets can rapidly and efficiently be distributed to a plurality of protocol processors, without imposing a load on the system due to reassembly of the packets, by distributing the packets to the plurality of protocol processors without reassembling the packets

In order to accomplish the above exemplary aspect and/or other exemplary features of the present invention, a packet distribution apparatus and a packet distribution method capable of distributing packets to a plurality of protocol processors without reassembling fragmented packets, are provided.

The packet distribution method for receiving a packet from the network and distributing the packet to one of a plurality of protocol processors comprises the step of determining whether the packet received is a first fragment, if the received packet is fragmented packet; if the received packet is the first fragment packet, the step of looking-up the tunnel ID and the fragment of the received packet, and comparing the result of the looked-up fragment with each list of the fragment look-up table into which the result of the looked-up fragment is entered, to determine if there is a corresponding list; the step of searching the index corresponding to the tunnel ID of the received packet from the tunnel ID look-up table, and if the list corresponding to the result of the looked-up fragment exists in the fragment look-up table, entering the index into the corresponding list of the fragment look-up table; and the step of attaching the index as a tag to the received packet and transmitting the received packet to the protocol processor.

The step of entering into the fragment look-up table is desirable to newly enter the result of the looked-up fragment and the index into the fragment look-up table if the list conforming to the result of the looked-up fragment does not exist in the fragment look-up table.

The packet distribution method further comprises, if the received packet is not the first fragment, the step of looking-up the fragment of the received packet, and comparing the result of the looked-up fragment with each list of the fragment look-up table to determine if there is a corresponding list; the step of entering the result of the looked-up fragment of the received packet into the fragment look-up table if the list conforming to the result of looked-up the fragment does not exist in the fragment look-up table; and the step of storing the received packet in a fragment buffer.

The step of transmitting the packet is desirable to attach the index as a tag to the packet that has been received and stored in the fragment buffer and transmit it to the protocol processor, if the received packet is the first fragment and the list conforming to the results of the looked-up fragment exists in the fragment look-up table.

The packet distribution method further comprises, if the list conforming to the result of the looked-up fragment exists in the fragment look-up table, the steps of determining whether the index corresponding to the result of the looked-up tunnel ID is entered into the corresponding list; and attaching the index as a tag to the received packet and transmitting the received packet to the protocol processors, if the index exists in the list.

Preferably, but not necessarily, the packet distribution method further comprises the step of storing the received packet in the fragment buffer if there is no index in the list.

On the other hand, the packet distribution apparatus that distributes packets to a plurality of protocol processors according to the present invention comprises a receiving unit for receiving the packets from network; a fragment look-up table storage unit for storing a fragment look-up table into which the result of the fragment looked-up on the received packet is entered; a fragment look-up device for comparing the result of the fragment looked-up on the received packet with each list of the fragment look-up table to determine whether the list corresponding to the result exists; a tunnel ID look-up table storage unit for storing a tunnel ID look-up table into which the index corresponding to the tunnel ID of the received packet is entered; a tunnel ID look-up device for searching the index corresponding to the result of the tunnel ID looked-up on the received packet from the tunnel ID look-up table to attach the index as a tag to the received packet; and a dependant interface for transmitting the packet attached with the index to one of the protocol processors.

If the list corresponding to the result of the looked-up fragment does not exist in the fragment look-up table, the fragment look-up device newly enters the result of the looked-up fragment and the index into the fragment look-up table in the case of the received packet being the first fragment, and newly enters the result of the looked-up fragment into the fragment look-up table in the case of the received packet not being the first fragment.

Preferably, but not necessarily, if the list corresponding to the result of the looked-up fragment and including the index does not exist in the fragment look-up table, the packet distribution apparatus further comprises a fragment buffer for storing the received packet in the case of the received packet not being the first fragment.

Preferably, but not necessarily, if the list corresponding to the result of the looked-up fragment and including the index exists in the fragment look-up table, the fragment look-up device attaches the index as a tag to the received packet to transmit the packet to one of the protocol processors.

Preferably, but not necessarily, in the case of the received packet being the first packet, the fragment look-up device attaches the index as a tag to the packets that are subsequent fragments following the first fragment and that are stored in the fragment buffer, to transmit the packets via the dependant interface to the protocol processors, if the lists conforming to the result of the looked-up fragments exist in the fragment look-up table.

### BRIEF DESCRIPTION OF THE DRAWINGS

Illustrative, non-limiting embodiments of the present invention will be explained with reference to the accompanying drawings, in which:

FIG. 1 is a block diagram showing the prior art packet distribution apparatus;

FIG. 2 is a block diagram showing another prior art packet distribution apparatus;

FIG. 3 is a block diagram showing the packet distribution apparatus according to the present invention;

FIG. 4 shows an example of fragment look-up table; and

FIG. 5 is a flow chart showing the operations of the packet distribution apparatus according to the present invention.

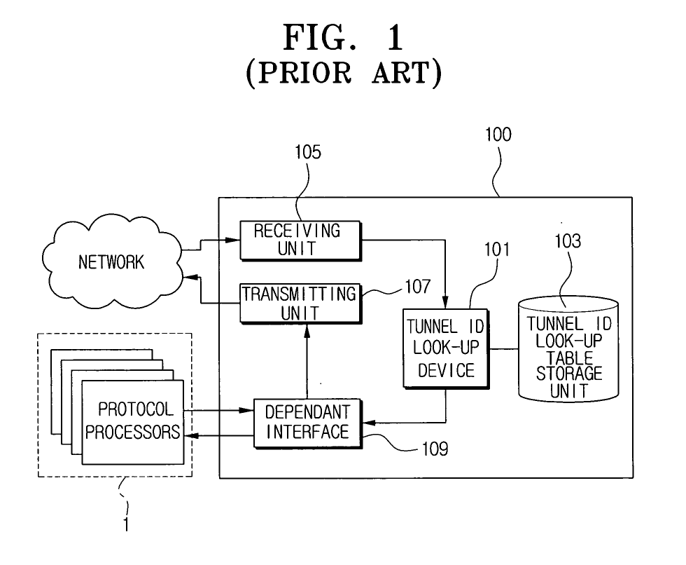

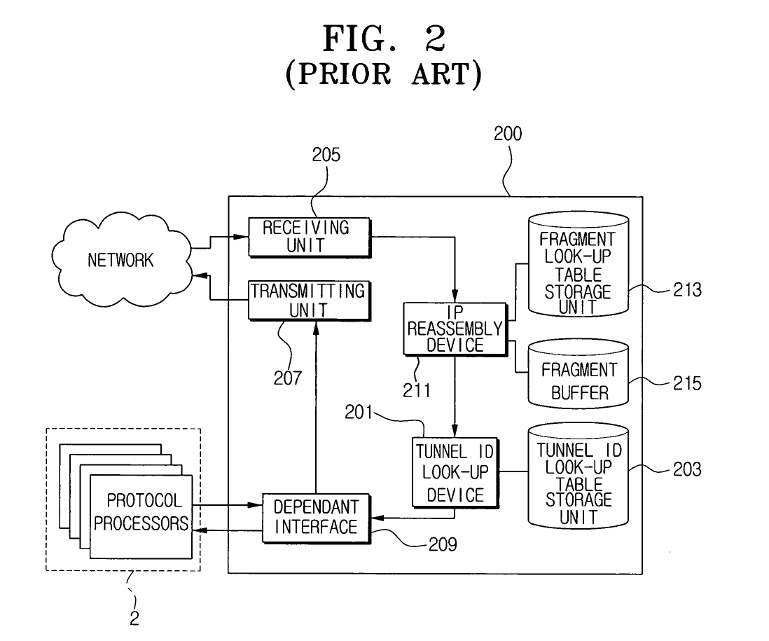

### DETAILED DESCRIPTION OF THE INVENTION

The above exemplary objects, as well as other exemplary objects, features and advantages of the present invention will be better understood from the following description taken in conjunction with the attached drawings.

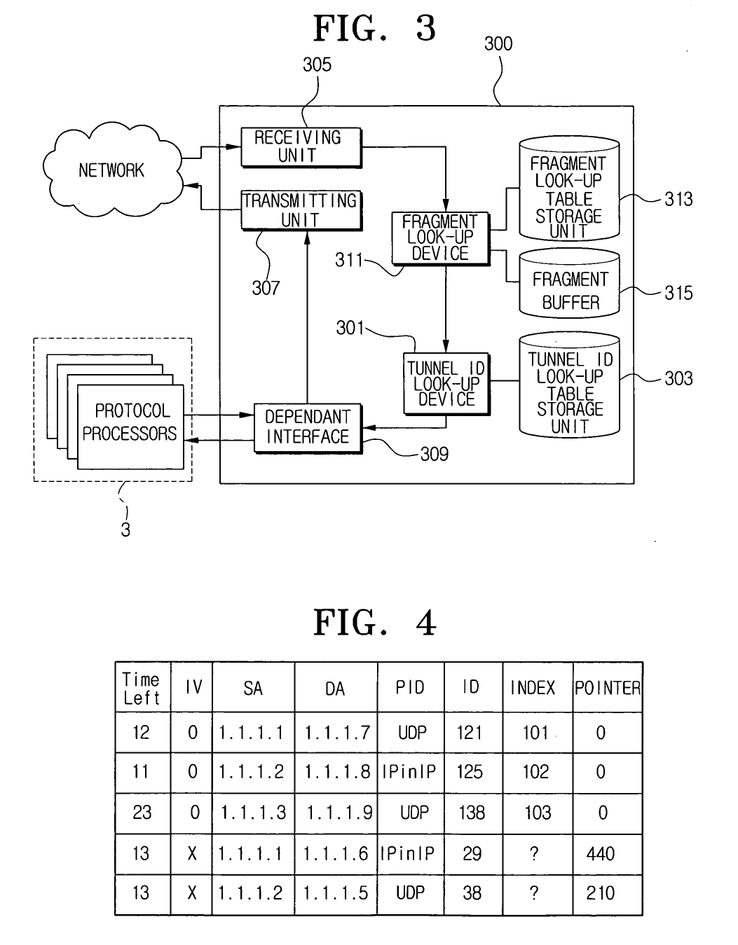

FIG. 3 is a block diagram showing the packet distribution apparatus 300 according to the present invention.

The packet distribution apparatus 300 comprises a fragment look-up device 311, a tunnel ID look-up device 301, a fragment look-up table storage unit 313, a fragment buffer 315, a tunnel ID look-up table storage unit 303, a receiving unit 305, a transmitting unit 307, and a dependant interface 309.

The packet distribution apparatus 300 receives/transmits the packet from/to a protocol processor 3 through the dependant interface 309.

The receiving unit 305 receives the packet from the network. Here, the network is described as a UMTS (Universal Mobile Telecommunications System) network, but is not limited to this.

The packet distribution apparatus 300 determines if the packet that is currently received is a fragmented packet using the IP header of the packet. In the case of the received packet not being a fragmented packet, the tunnel ID look-up device 301 looks-up the tunnel ID of the received packet, retrieves the tunnel ID look-up table in the tunnel ID look-up table storage unit 303 to search an index indicating one of the protocol processors 3 corresponding to the tunnel ID from the tunnel ID look-up table and to attach the index as a tag to the received packet, and transmits the received packet via the dependant interface 309 to the corresponding one of the protocol processors 3.

In the case of the packet that is currently received being a fragmented packet, the fragment look-up device 311 determines if the current packet is a first fragment.

If the received packet is the first fragment, the tunnel ID look-up device 301 looks-up the tunnel ID of the received current packet, retrieves the tunnel ID look-up table held in the tunnel ID look-up table storage unit 303 to search a corresponding index from the tunnel ID look-up table and to attach the index as a tag to the current packet, and transmits the current packet via the dependant interface 309 to the corresponding one of the protocol processors 3.

If the current packet is the first fragment, the fragment look-up device 311 looks-up the fragment IP header of the packet (hereinafter, to be referred to as “fragment look-up”), and compares the result of the looked-up fragment, such as a source address (SA), a destination address (DA), a protocol ID (PID), and a fragment ID (ID), with each list of the fragment look-up table to determine if there is a corresponding list in the fragment look-up table.

If there is no corresponding list in the fragment look-up table, the fragment look-up device 311 enters the result of the looked-up fragment as a new list into the fragment look-up table, and enters the index into the location corresponding to the new list in the fragment look-up table. However, if there is the corresponding list in the fragment look-up table, the fragment look-up device 311 enters the index of the current packet into the corresponding list in the fragment look-up table and updates the fragment look-up table.

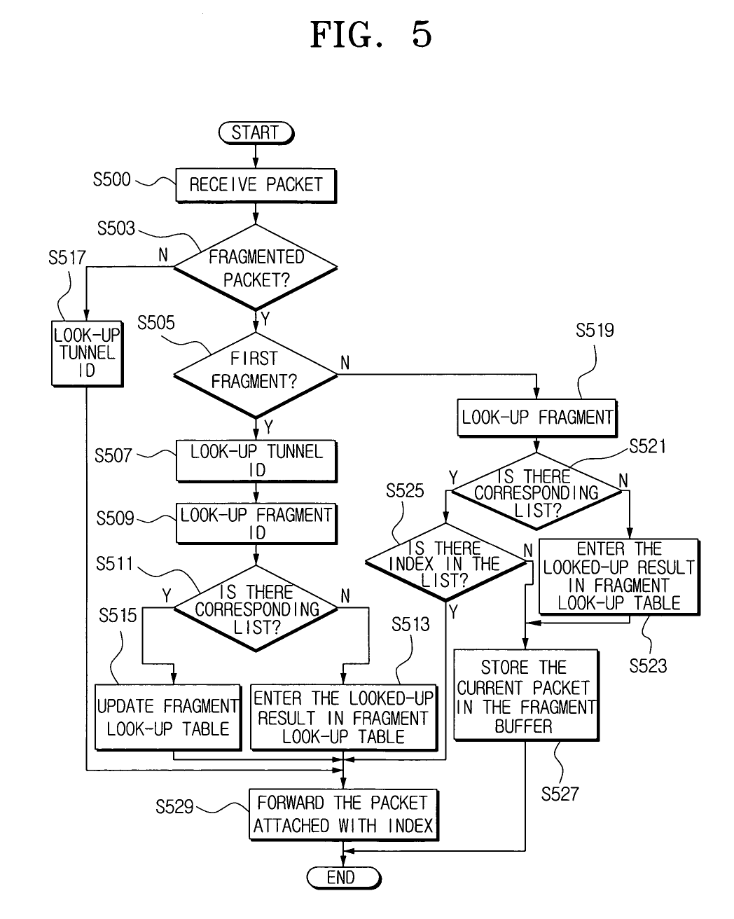

FIG. 4 shows an example of the fragment look-up table. In FIG. 4, “IV” indicates if the index value is valid. In other words, if the value of “IV” is “1”, this indicates that the index value of the corresponding list is valid and the first fragment has already received. Conversely, if the value of “IV” is “0” (hereinafter, to be referred to as “stand-by”), this means that a second fragment or subsequent fragments are firstly received before receiving the first fragment, thereby the index value validly does not exist in the corresponding list. When the value of “IV” is “0”, SA, DA, PID, and ID values being the result of the looked-up fragment are entered into the fragment look-up table, and the fragment that has already been received is stored in the fragment buffer 315.

On the other hand, in FIG. 4, “Time Left” indicates the time during which the fragment buffer 315 validly should hold the corresponding list of the look-up table. The maximum holding time may be appropriately adjusted according to the system. Here, for example, let it be 25 seconds. Accordingly, during the maximum holding time (here, 25 seconds), if there is no result of the looked-up-fragment conforming to the list of the look-up table and hence that list is not accessed, the corresponding list is removed. With reference to the first list of FIG. 4, if the thirteen seconds have passed since the corresponding list had been finally accessed, and the corresponding list is not accessed during the twelve seconds since then, the corresponding list is removed from the fragment look-up table. Therefore, if the transmissions of the corresponding fragments are entirely completed, or some of the fragments are lost during the transmissions, it is possible to prevent the resources of the fragment look-up table storage unit 303 from being consumed due to the invalid list.

If the list corresponding to the result of the looked-up fragment on the received packet does not exist in the fragment look-up table, this corresponds to the case where the received current packet is firstly arrived.

On the other hand, in the event that the received current packet is not the first fragment, it is impossible to look-up the tunnel ID as described above, and therefore, the fragment look-up device 311 performs the fragment look-up, and compares the result of the looked-up fragment with the list of the fragment look-up table to determine if the list conforming to the result exists in the table.

If the list corresponding to the result does not exist in the table, the fragment look-up device 311 enters the result of the looked-up fragment as a new list into the fragment look-up table, storages the received packet in the fragment buffer 315, and enters its address value into the pointer item of the fragment look-up table.

If the list corresponding to the result exists in the table, the fragment look-up device 311 determines whether the corresponding valid index is included in the list. If there is included the corresponding index, the device 311 attaches the corresponding index as a tag to the current packet to transmit the packet via the dependant interface 309 to the corresponding one of the protocol processors 3. However, if there is no the corresponding index, the device 311 stores the current packet in the fragment buffer 315 and links its address value to the pointer value in the list.

Upon receiving a packet, in the case where there is a packet that has already been stored in the fragment buffer 315 and is under the stand-by, if the currently received packet is the first packet, the fragment look-up device 311 transmits the current packet and then attaches the index of the current packet as a tag to the stand-by packet to transmit it to the corresponding one of the protocol processors 3. However, if the currently received packet is not the first packet, the fragment look-up device 311 stores the current packet in the fragment buffer 315, and links its address value to the pointer value in the list. Consequently, after the first packet has been received, it is possible to forward all of the packets following the first packet that are under the stand-by in the fragment buffer 315.

FIG. 5 is a flow chart showing the operations of the packet distribution apparatus having a forwarding engine according to the present invention. Hereinafter, a method for distributing IP fragment packets, without IP reassembly, using the present packet distribution apparatus will be described with reference to FIG. 5.

If the packet distribution apparatus 300 receives a packet from the network (S500), it determines whether the received current packet is a fragmented packet (S503).

If the received current packet is not a fragmented packet, the packet distribution apparatus 300 looks-up the tunnel ID of the received packet (S517), and searches a corresponding index by retrieving the tunnel ID look-up table to attach the index as a tag to the received packet and then forward the packet to corresponding one of the protocol processors 3 (S529).

On the other hand, if the received current packet is a fragmented packet, the packet distribution apparatus 300 determines whether the current packet is a first fragment (S505).

If the current packet is the first fragment, the packet distribution apparatus 300 looks-up the tunnel ID of the current packet (S507), and looks-up the fragment ID of the current packet (S509). Then, the packet distribution apparatus 300 compares the result of the looked-up fragment ID with each list of the fragment look-up table to determine whether the list conforming to the result of the looked-up fragment ID exists in the table (S511).

In the event that in the fragment look-up table, there is no the list conforming to the result of the fragment ID looked-up on the received packet, the packet distribution apparatus 300 enters as a new list the result of the fragment ID looked-up on the current packet into the fragment look-up table and retrieves the tunnel ID table, thereby searching the index corresponding to the tunnel ID of the current packet (S513). Thereafter, the packet distribution apparatus 300 attaches the searched index to the current packet being the first fragment, thereby forwarding the packet to the corresponding one of the protocol processors 3 (S529).

In the event that in the fragment look-up table, there exists the list conforming to the result of the fragment ID looked-up on the received packet, the packet distribution apparatus 300 enters the index value of the current packet retrieved from the tunnel ID table and updates the fragment look-up table (S515), and attaches the index to the current packet thereby forwarding the packet to corresponding one of the protocol processors 3 (S529).

On the other hand, if the current packet is not the first fragment, the packet distribution apparatus 300 performs the fragment ID look-up on the current packet (S519), and determines whether there is a corresponding list in the fragment look-up table (S521). If there is no the corresponding list, the packet distribution apparatus 300 enters as a new list the result of the fragment ID looked-up on the current packet into the fragment look-up table (S523) and stores the current packet in the fragment buffer (S527).

In the event that in the fragment look-up table, there exists the list conforming to the result of the fragment looked-up on the current packet, the packet distribution apparatus 300 determines if the index of the corresponding list validly exists in the list (S525). If the index exists in the list, the packet distribution apparatus 300 attaches the index as a tag to the current packet to forward the packet to the corresponding one of the protocol processors 3 (S529). However, if the index does not exist in the list, the packet distribution apparatus 300 stores the current packet in the fragment buffer (S527).

As has been described so far, the packet distribution apparatus and a distribution method according to the present invention stores subsequent fragment packets following a first fragment packet temporarily in the fragment buffer until the first packet is received, wherein the subsequent fragment packets do not include the tunnel ID and hence no index could be found for the subsequent fragment packets; and after the first packet has been received, looks-up that tunnel ID and searches the index corresponding to that tunnel ID to attach the index as a tag to the subsequent fragment packets; and transmits the packets to the corresponding one of the protocol processors. Therefore, in accordance with the packet distribution apparatus and the packet distribution method of the present invention, it is possible to distribute the packets to a plurality of protocol processors without reassembly of the fragment packets.

Additionally, in accordance with the packet distribution apparatus and packet distribution method of the present invention, since it is not necessary to reassemble the fragmented packets in order to distribute the packets, it is possible to efficiently distribute the packets to a plurality of protocol processors without consuming resources and time for reassembling the packets.

The technical spirit of the present invention has been disclosed with reference to the appended drawings and the description of various illustrative, non-limiting embodiments of the present invention corresponding to the drawings. Those who are skilled in the art will appreciate that various modifications, additions and substitutions are possible without departing from the scope and spirit of the present invention. Therefore, it should be understood that the present invention is limited only to the accompanying claims and the equivalents thereof, and includes the aforementioned modifications, additions and substitutions.

What is claimed is:

1. A method for receiving a plurality of packets from a network and distributing the packets to a plurality of protocol processors comprising the steps of:
if a received packet is a fragmented packet, determining whether the received packet is a first fragment packet;
if the received packet is the first fragment packet, looking-up a tunnel ID of the received packet and a fragment ID of the received packet, and comparing the result of the looked-up fragment ID with each list of a fragment look-up table into which the results of fragment looked-ups for other received packets are entered, to determine if there is a corresponding list;
searching an index indicating one of the protocol processors and corresponding to the tunnel ID of the received packet from a tunnel ID look-up table, and if the list corresponding to the result of the looked-up fragment ID exists in the fragment look-up table, entering the index into the corresponding list of the fragment look-up table; and
attaching the index as a tag to the received packet and transmitting the received packet to the corresponding one of the protocol processors.

2. The method of claim 1, wherein the step of entering the index into the corresponding list of the fragment look-up table, includes newly entering the result of the looked-up fragment ID and the index into the fragment look-up table, if the list corresponding to the result of the looked-up fragment ID does not exist in the fragment look-up table.

3. The method of claim 1, wherein the step of transmitting the received packet includes attaching the index as the tag to a packet that has been previously received and stored in a fragment buffer and transmitting the previously received and stored packet to the corresponding one of the protocol processors, if the received packet is the first fragment and the list corresponding to the result of the looked-up fragment exists in the fragment look-up table.

4. The method of claim 1, wherein if the received packet is not the first fragment, further comprising the steps of:
looking-up the fragment ID of the received packet and comparing the result of the looked-up fragment ID with each list of the fragment look-up table, to determine if there is a corresponding list;
entering the result of the fragment ID looked-up for the received packet into the fragment look-up table, if the list corresponding to the result of the looked-up fragment does not exist in the fragment look-up table; and
storing the received packet in a fragment buffer.

5. The method of claim 4, wherein if the list corresponding to the result of the looked-up fragment ID exists in the fragment look-up table, further comprising the steps of:
determining whether the index corresponding to the result of the tunnel ID look-up exists in the corresponding list; and
attaching the index as the tag to the received packet and transmitting the received packet to the corresponding one of the protocol processors, if the index exists in the corresponding list.

6. The method of claim 5, further comprising the step of storing the received packet in the fragment buffer, if the index does not exist in the corresponding list.

7. An apparatus for distributing a plurality of packets to a plurality of protocol processors comprising:
a receiving unit for receiving the packets from a network;
a fragment look-up table storage unit for storing fragment look-up table into which the result of a fragment looked-up on the received packet is entered;
a fragment look-up device for comparing the result of the fragment looked-up on the received packet with each list of the fragment look-up table, to determine whether the list corresponding to the result exists;
a tunnel ID look-up table storage unit for storing a tunnel ID look-up table having lists of indexes indicating the protocol processors corresponding to the tunnel IDs of the packets, respectively;
a tunnel ID look-up device for searching the index corresponding to the result of the tunnel ID looked-up on the received packet from the tunnel ID look-up table to attach the index as a tag to the received packet; and
a dependant interface for transmitting the packet attached with the index to the corresponding one of the protocol processors.

8. The apparatus of claim 7, wherein if the list corresponding to the result of the looked-up fragment does not exist in the fragment look-up table, the fragment look-up device newly enters the result of the looked-up fragment and the index into the fragment look-up table, if the received packet is a first fragment, and newly enters the result of the looked-up fragment into the fragment look-up table, if the received packet is not the first fragment.

9. The apparatus of claim 7, further comprising, if the list corresponding to the result of the looked-up fragment and including the index does not exist in the fragment look-up table, a fragment buffer for storing the received packet if the received packet is not the first fragment.

10. The apparatus of claim 9, wherein if the list corresponding to the result of the looked-up fragment and including the index exists in the fragment look-up table, the fragment look-up device attaches the index as the tag to the received packet to transmit the received packet to the corresponding one of the protocol processors.

11. The apparatus of claim 9, wherein in the case of the received packet being the first fragment, the fragment look-up device attaches the index as the tag to each packet being a subsequent fragment following the first fragment and being stored in the fragment buffer to transmit each subsequent fragment packet via the dependant interface to the corresponding one of the protocol processors, if the list conforming to the result of the looked-up fragment exists in the fragment look-up table.
